(19) United States
(12) Patent Application Publication
(10) Pub. No.: US 2005/0041840 A1
(43) Pub. Date: Feb. 24, 2005

(54) MOBILE PHONE WITH AN IMAGE RECOGNITION FUNCTION

(76) Inventor: Jui-Hsiang Lo, Taipei City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/605,836

(22) Filed: Oct. 30, 2003

(30) Foreign Application Priority Data
Aug. 18, 2003 (TW) 092122666

(51) Int. Cl. H04N 7/14; G06K 9/00

(52) U.S. Cl. 382/118; 348/14.01

(57) ABSTRACT

A mobile phone with image recognition function for allowing users to use the mobile phone according to an image recognition acknowledgement result includes a housing, an image-capturing module including a lens for capturing an image, and an image recognition module installed inside the housing for recognizing the image captured by the lens of the image-capturing module.

### BACKGROUND OF INVENTION

1. Field of the Invention

The present invention relates to a mobile phone, and more specifically, to a mobile phone with an image recognition function for allowing users to use the mobile phone according to an image recognition acknowledgement result.

2. Description of the Prior Art

In the modern information society, wireless communication developments let people communicate with each other more easily. For example, people can communicate with other people by using mobile phones to exchange their information.

Nowadays mobile phones have become very popular because of the decreasing price and the improvement of technology. So more and more mobile phones enter the market. Manufacturers also add more additional features and functions in their mobile phones to satisfy all kinds of consumers, like sending personal words and images to another mobile phone, browsing the internet, receiving and sending email, listening to the radio, and even using the electronic commerce service with the wireless network function. Mobile phones are very close to peoples life.

Due to rapid development of information networks, information security and data transmission safety are always the focuses of relating research. The security mechanism of a conventional server and database login system, such as for entering personal computers or mobile phones, is usually implemented by inputting a secret code. However the conventional password protect model is inadequate for the present security demand. The cryptosecurity of the present mobile phone only lets a user login to the mobile phone according to the password of the mobile phone or the Personal Identity Number code (PIN code) of a SIM card. That is, users login to mobile phones and are allowed to use the communication service of mobile phones by inputting a password. The conventional recognition system is really inadequate for personal communication devices with many powerful functions, especially for electronic commerce services and online trading. It is very important that the safety and privacy of the security system are perfect on personal communication devices.

### SUMMARY OF INVENTION

It is therefore a primary objective of the present invention to provide a mobile phone with an image recognition function for allowing users to use the mobile phone according to an image recognition acknowledgement result to solve the problems mentioned above.

Briefly summarized, a mobile phone with an image recognition function for allowing users to use the mobile phone according to an image recognition acknowledgement result is proposed. The mobile phone includes a housing, an image-capturing module including a lens for capturing an image, and an image recognition module installed inside the housing for recognizing the image captured by the lens of the image-capturing module.

Briefly summarized, a method for allowing users to use a mobile phone according to an image recognition acknowledgement result is proposed. The mobile phone includes a housing, a control module, and a memory. The method includes (a) providing an image-capturing module comprising a lens, and using the image-capturing module to capture an image; (b) providing an image recognition module installed inside the housing of the mobile phone, and using the image recognition module to compare the image captured by the image-capturing module with image data previously stored in the memory; and (c) after step (b), if the image captured by the image-capturing module corresponds with the image data stored in the memory, sending a corresponding identification code to the control module with the image recognition module.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a mobile phone according to a first embodiment of the present invention.

FIG. 2 is an outward diagram of the mobile phone according to the first embodiment of the present invention.

FIG. 3 is a flowchart illustrating using an image recognition acknowledgement result to allow users to use the mobile phone.

FIG. 4 is a block diagram of a mobile phone according to a second embodiment of the present invention.

FIG. 5 is an outward diagram of the mobile phone according to the second embodiment of the present invention.

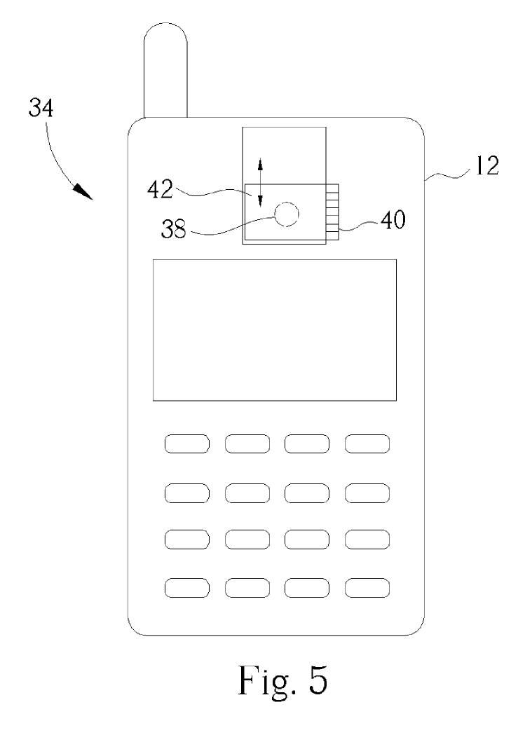

### DETAILED DESCRIPTION

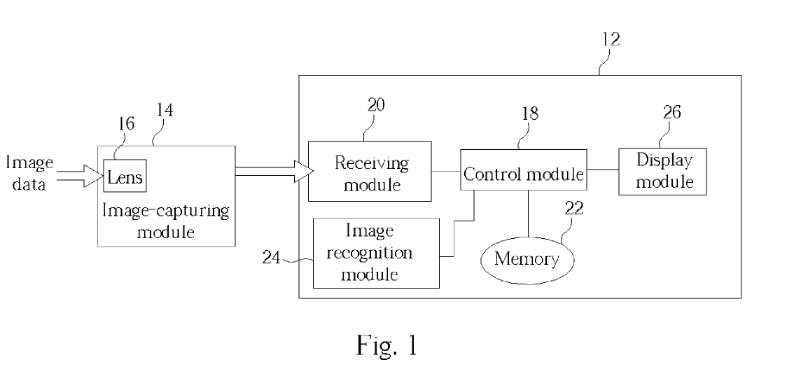

Please refer to FIG. 1. FIG. 1 is a block diagram of a mobile phone 10 with an image recognition function according to a first embodiment of the present invention. The mobile phone 10 includes a housing 12, an image-capturing module 14 including a lens 16 for capturing a picture of a users face of the mobile phone 10. The image-capturing module 14 can be an external phone camera installed outside the housing 12 of the mobile phone 10. The mobile phone 10 further includes a control module 18 installed inside the housing 12 for controlling the mobile phone 10, a receiving module 20 installed inside the housing 12 and electrically connected to the control module 18 for receiving image data transmitted from the image-capturing module 14, a memory 22 installed inside the housing 12 and electrically connected to the control module 18 for storing image data transmitted from the image-capturing module 14 and operating data of the mobile phone 10. The memory 22 can be any type of storage media, such as a CF, SD, or MMC card. The mobile phone 10 further includes an image recognition module 24 installed inside the housing 12 for recognizing the image captured by the lens 16 of the image-capturing module 14, and a display module 26 installed inside the housing 12 and electrically connected to the control module 18 for displaying the image data received by the receiving module 20 and displaying operation information of the control module 18 to users. The display module 26 can be an LCD.

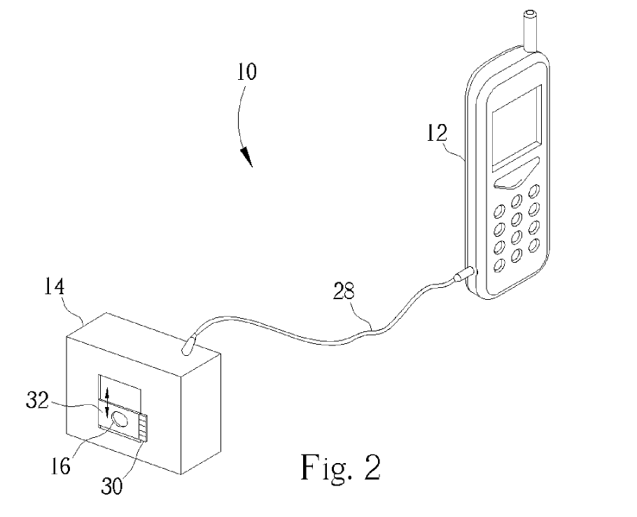

Please refer to FIG. 2. FIG. 2 is an outward diagram of the mobile phone 10 according to the first embodiment of the present invention. The image-capturing module 14 is connected to the housing 12 by a cable 28. The mobile phone 10 further includes a sliding set 30 installed on the housing of the image-capturing module 14 in a slidable manner, and an IR cut filter 32 installed on the sliding set 30 for stopping infrared rays from passing through the lens 16 of the image-capturing module 14. When the image-capturing module 14 is used to capture an image for image recognition, the sliding set 30 needs to slide upwards from the lens 16 to remove the IR cut filter 32 from the front of the lens 16 of the image-capturing module 14. Therefore the image-capturing module 14 can receive infrared rays and build the infrared pattern of the users face. When the image-capturing module 14 is not used to capture the image for image recognition but instead for general photos, the sliding set 30 needs to slide to the front of the lens 16 to move the IR cut filter 32 to the front of the lens 16 of the image-capturing module 14. Therefore the image-capturing module 14 cannot receive infrared rays because the IR cut filter 32 stops infrared rays from passing through the lens 16 of the image-capturing module 14. So there is no aberration problem on the image captured by the image-capturing module 14 because of filtering infrared rays with the IR cut filter 32.

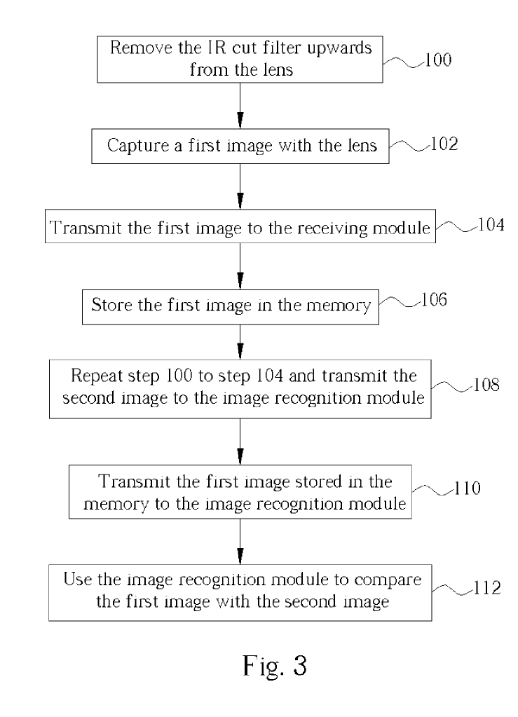

Please refer to FIG. 3. FIG. 3 is a flowchart illustrating using an image recognition acknowledgement result to allow users to use the mobile phone 10. The method includes:
Step 100: move the sliding set 30 upwards from the lens 16 to remove the IR cut filter 32 from the front of the lens 16 of the image-capturing module 14;
Step 102: use the lens 16 of the image-capturing module 14 to capture a first image;
Step 104: transmit the first image captured by the image-capturing module 14 to the receiving module 20;
Step 106: use the control module 18 to store the first image received by the receiving module 20 in the memory 22;
Step 108: 1repeat step 100 to step 104 and generate a second image. Use the control module 18 to transmit the second image received by the receiving module 20 to the image recognition module 24;
Step 110: Use the control module 18 to transmit the first image stored in the memory 22 to the image recognition module 24; and
Step 112: Use the image recognition module 24 to compare the first image with the second image. If the first image corresponds with the second image, the image recognition module 24 sends a corresponding identification code to the control module 18 of the mobile phone 10.

The detailed description of the actions listed above is as follows. When the image-capturing module 14 is used to capture an image of a user for image recognition, the sliding set 30 slides upwards from the lens 16 to remove the IR cut filter 32 from the front of the lens 16 of the image-capturing module 14. Therefore the image-capturing module 14 can receive infrared rays and build the infrared pattern of the users face. The infrared pattern of the users face can improve the correct recognition rate and be distinguished from a photo of the users face. Additionally the face recognition is accurate in a low-luminance condition due to the use of infrared rays.

First the user has to build up the first image of his own face and store the first image in the memory 22 for the comparison basis of the image recognition. When the user wants to login the mobile phone 10, step 100 to step 104 have to be repeated and the second image of the infrared pattern of the users face is generated. And then the image recognition module 24 will compare the first image stored in the memory 22 previously with the second image. If the first image corresponds with the second image, the image recognition module 24 will send a corresponding identification code to the control module 18 of the mobile phone 10. When the control module 18 receives the corresponding identification code, the control module 18 will boot the mobile phone 10 or allow the user to operate the functions of the mobile phone 10.

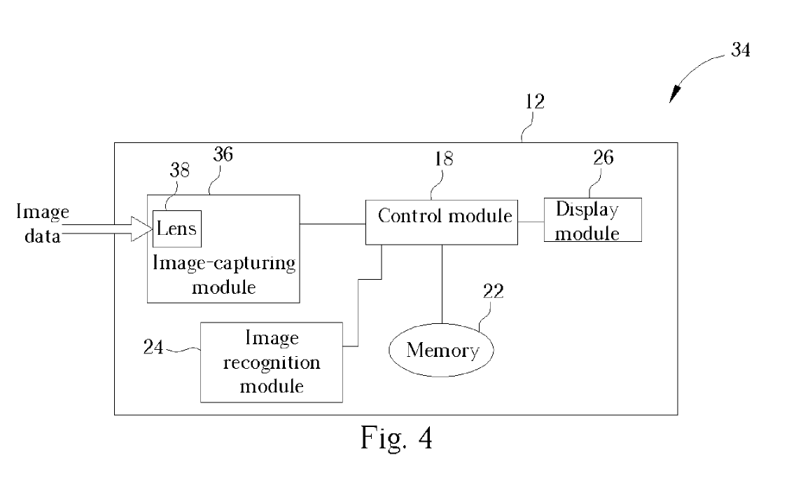

The image-capturing module 14 can also be installed on the housing 12 of the mobile phone 10. Please refer to FIG. 4. FIG. 4 is a block diagram of a mobile phone 34 according to a second embodiment of the present invention. The mobile phone 34 includes a housing 12, an image-capturing module 36 including a lens 38 for capturing a picture of a users face of the mobile phone 34. The image-capturing module 36 can be a phone camera installed on the housing 12 of the mobile phone 34. The mobile phone 34 further includes a control module 18 installed inside the housing 12 for controlling the mobile phone 34, and a memory 22 installed inside the housing 12 and electrically connected to the control module 18 for storing image data captured by the image-capturing module 36 and operating data of the mobile phone 34. The memory 22 can be any type of storage media, such as a CF, SD, or MMC card. The mobile phone 34 further includes an image recognition module 24 installed inside the housing 12 for recognizing the image captured by the lens 38 of the image-capturing module 36, and a display module 26 installed inside the housing 12 and electrically connected to the control module 18 for displaying the image data captured by the image-capturing module 36 and displaying operation information of the control module 18 to users. The display module 26 can be an LCD.

The working principle of the second embodiment is the same as the one of the first embodiment, so the detailed description is omitted.

In the embodiments of the present invention, the IR cut filter moves to the front of the lens or is removed from the front of the lens by sliding the sliding set. The connection between the IR cut filter of the present invention and the mobile phone can be of other types, such as detachable or rotatable types, and is not limited to this sliding manner. The emphasis on the present invention is that the IR cut filter is removed from the front of the lens 16 for image recognition, and the IR cut filter moves to the front of the lens for general photos. It can depend on whether the infrared rays are shaded or not.

In contrast to the prior art, the present invention provides the mobile phone with image-capturing and image recognition functions. An infrared pattern of a users face can be built up with the image-capturing module and by switching the IR cut filter on the sliding set for receiving the infrared rays. The infrared pattern of the user's face can improve the correct recognition rate and be distinguished from a photo of the users face. Additionally the face recognition function is accurate in a low-luminance condition due to the use of infrared rays. The image captured in a low-luminance condition is also clear due to the use of infrared rays. When the image-capturing module is used for general photos, the IR cut filter has to be moved to the front of the lens. Therefore the image-capturing module cannot receive infrared rays because the IR cut filter stops infrared rays from passing through the lens of the image-capturing module. So there is no aberration problem on the image captured by the image-capturing module because of filtering infrared rays by the IR cut filter. In conclusion, the present invention provides a mobile phone with an image recognition function for allowing users to use the mobile phone according to an image recognition acknowledgement result instead of a password identification mechanism. The present invention can provide a more effective security system on personal communication devices.

Those skilled in the art will readily observe that numerous modifications and alterations of the device may be made while retaining the teachings of the invention. Accordingly, the above disclosure should be construed as limited only by the metes and bounds of the appended claims.

1. A mobile phone with an image recognition function for allowing users to use the mobile phone according to an image recognition acknowledgement result, the mobile phone comprising:
a housing;
an image-capturing module comprising a lens for capturing an image; and
an image recognition module installed inside the housing for recognizing the image captured by the lens of the image-capturing module.

2. The mobile phone of claim 1 further comprising an IR cut filter for stopping infrared rays from passing through the lens of the image-capturing module.

3. The mobile phone of claim 2 wherein the IR cut filter is installed above the lens in a movable manner.

4. The mobile phone of claim 3 further comprising a sliding set installed on the housing in a slidable manner, wherein the IR cut filter is installed on the sliding set.

5. The mobile phone of claim 1 wherein the image-capturing module is an external phone camera installed outside the housing.

6. The mobile phone of claim 1 wherein the image-capturing module is a phone camera installed on the housing of the mobile phone.

7. The mobile phone of claim 1 further comprising:
a control module installed inside the housing for controlling the mobile phone; and
a memory installed inside the housing and electrically connected to the control module for storing image data recognized by the image recognition module;
wherein when the image captured by the image-capturing module corresponds with image data previously stored in the memory, a corresponding identification code will be sent by the image recognition module to the control module.

8. The mobile phone of claim 7 wherein when the control module receives the corresponding identification code, the control module will boot the mobile phone.

9. The mobile phone of claim 1 wherein the image is a pattern of a persons face.

10. A method for allowing users to use a mobile phone according to an image recognition acknowledgement result, the mobile phone comprising a housing, a control module, and a memory, the method comprising:
(a) providing an image-capturing module comprising a lens, and using the image-capturing module to capture an image;
(b) providing an image recognition module installed inside the housing of the mobile phone, and using the image recognition module to compare the image captured by the image-capturing module with image data previously stored in the memory; and
(c) after step (b), if the image captured by the image-capturing module corresponds with the image data stored in the memory, sending a corresponding identification code to the control module with the image recognition module.

11. The method of claim 10 further comprising providing an IR cut filter for stopping infrared rays from passing through the lens of the image-capturing module, wherein in step (a), when the image-capturing module is used to capture the image for image recognition, the IR cut filter is removed from the front of the lens of the image-capturing module, and when the image-capturing module is not used to capture the image for image recognition but for photo, the IR cut filter is moved to the front of the lens of the image-capturing module.

12. The method of claim 11 further comprising providing a sliding set installed on the housing in slidable manner, and installing the IR cut filter on the sliding set.

13. The method of claim 10 wherein the image-capturing module is an external phone camera installed outside the housing.

14. The method of claim 10 wherein the image-capturing module is a phone camera installed on the housing of the mobile phone.

15. The method of claim 10 wherein the image is a pattern of a persons face.

16. The method of claim 10 further comprising when the control module receives the corresponding identification code, booting the mobile phone.
